(19) United States
(12) Patent Application Publication
(10) Pub. No.: US 2025/0342128 A1
(43) Pub. Date: Nov. 6, 2025

(54) STATIC SERIAL PERIPHERAL INTERCONNECT SCHEDULE

(71) Applicant: Rivian IP Holdings, LLC, Irvine, CA (US)

(72) Inventors: Adam Lee BERGER, Kanab, UT (US); Jonathan SOLNIT, San Jose, CA (US); Randy LONG, Irvine, CA (US)

(21) Appl. No.: 19/197,853

(22) Filed: May 2, 2025

Related U.S. Application Data
(60) Provisional application No. 63/643,401, filed on May 6, 2024.

(51) Int. Cl. G06F 13/16; G06F 13/40

(52) U.S. Cl. CPC G06F 13/1668; G06F 13/4068

(57) ABSTRACT

A PCB has a plurality of peripheral controllers mounted to the PCB, each peripheral controller including one or more registers. A bus is secured to the PCB and including one or more data lines each data line of the one or more data lines coupled to each peripheral controllers of the plurality of peripheral controllers. A memory is mounted to the PCB. A microcontroller is mounted to the PCB and coupled to the memory and the bus. The microcontroller configured to transmit and receive data to each peripheral controller of the plurality of peripheral controllers according to a static schedule in which for each cycle of the static schedule, each time window of a plurality of time windows is statically dedicated to exchange of data with each peripheral controller of the plurality of peripheral controllers corresponding to each time window.

### RELATED APPLICATIONS

This application claims the benefit of U.S. Provisional Patent Application Ser. No. 63/643,401 filed May 6, 2024 and entitled STATIC SERIAL PERIPHERAL INTERCONNECT SCHEDULE, which is hereby incorporated herein by reference in its entirety.

### INTRODUCTION

The present disclosure relates to the exchange of data with peripheral controllers, such as peripheral controllers of a vehicle.

### SUMMARY

The present disclosure describes an approach for communicating with peripheral devices of a vehicle. In one aspect, an apparatus includes a printed circuit board and a plurality of peripheral controllers mounted to the printed circuit board, each peripheral controller including one or more registers and configured to control operation of a corresponding peripheral according to values stored in the one or more registers. A bus is secured to the printed circuit board and includes one or more data lines, each data line of the one or more data lines coupled to each peripheral controller of the plurality of peripheral controllers. A memory is mounted to the printed circuit board. A microcontroller is mounted to the printed circuit board and coupled to the memory and the bus. The microcontroller is configured to transmit and receive data to each peripheral controller of the plurality of peripheral controllers according to a static schedule in which, for each cycle of the static schedule, each time window of a plurality of time windows is statically dedicated to exchange of data with each peripheral controller of the plurality of peripheral controllers corresponding to each time window.

### BRIEF DESCRIPTION OF THE DRAWINGS

FIG. 1A illustrates an example vehicle that may be operated in accordance with certain embodiments.

FIG. 1B illustrates a chassis of a vehicle in accordance with certain embodiments.

FIG. 2 is a schematic block diagram of components for operating the vehicle in accordance with certain embodiments.

FIG. 3 is schematic diagram showing components for exchanging data between an application and peripheral controllers in accordance with certain embodiments.

FIG. 4 is a process flow diagram of a method for exchanging data with peripheral controllers in accordance with certain embodiments.

FIG. 5 is a schematic diagram showing data structures for exchanging data with peripheral controllers in accordance with certain embodiments.

FIG. 6 is a schematic diagram illustrating a schedule table in accordance with certain embodiments.

FIG. 7 is a schematic diagram illustrating the execution of a schedule table in accordance with certain embodiments.

### DETAILED DESCRIPTION

A modern vehicle includes many electronic components, each of which may require a peripheral controller to interface therewith. The peripheral controller may be a relatively simple device that is not capable of asynchronous communication or communicating according to a networking protocol.

A microcontroller is implemented and executes a static schedule with respect to entries of a schedule table. Each entry corresponds to a cycle and a time window within the cycle. During each time window, the microcontroller asserts a chip select line and processes hardware instructions with respect to the peripheral controller associated with the time window, which includes transferring data with respect to an entry of the schedule table.

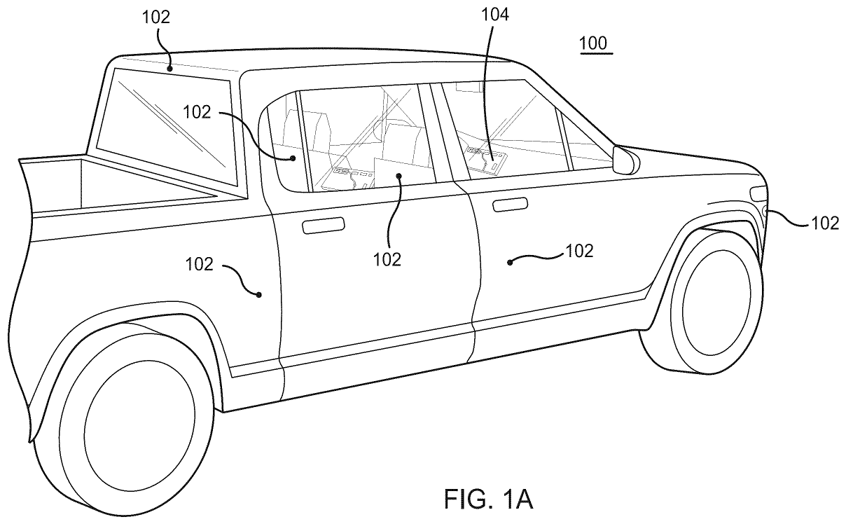

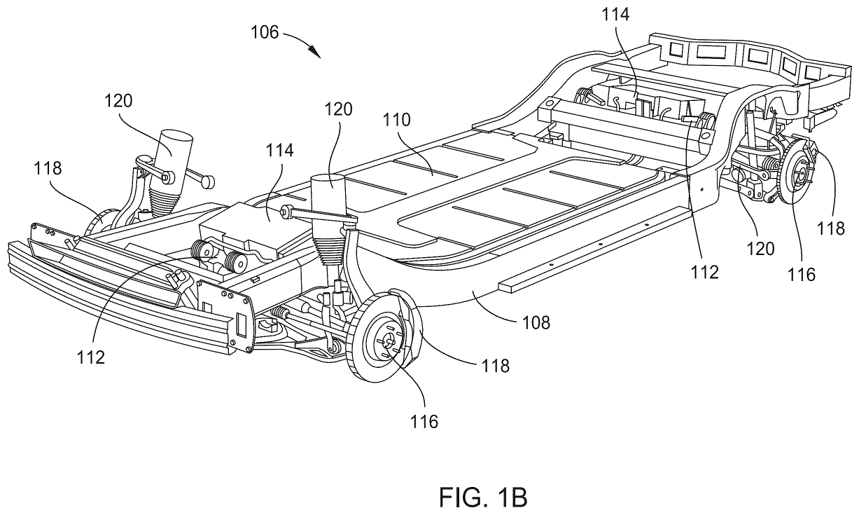

FIG. 1A illustrates an example vehicle 100. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by power electronics 114 of each drive unit 112. The power electronics 114 may include inverters configured to convert direct current (DC) from the battery 110 into alternating current (AC) supplied to the motors of the drive units 112. The power electronics 114 further facilitate operation of the motors of the drive units as generators to provide regenerative braking. The power electronics 114 further facilitate the transfer of regenerative current to the battery 110.

The drive units 112 are coupled to two or more hubs 116 to which wheels may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that may have a portion that is idled during some modes of operation. For example, a front or rear differential of an all-wheel drive vehicle. In another example, in a hybrid drive train, an idled drive unit including an electric motor may be heated with waste heat from an ICE according to the approaches described herein.

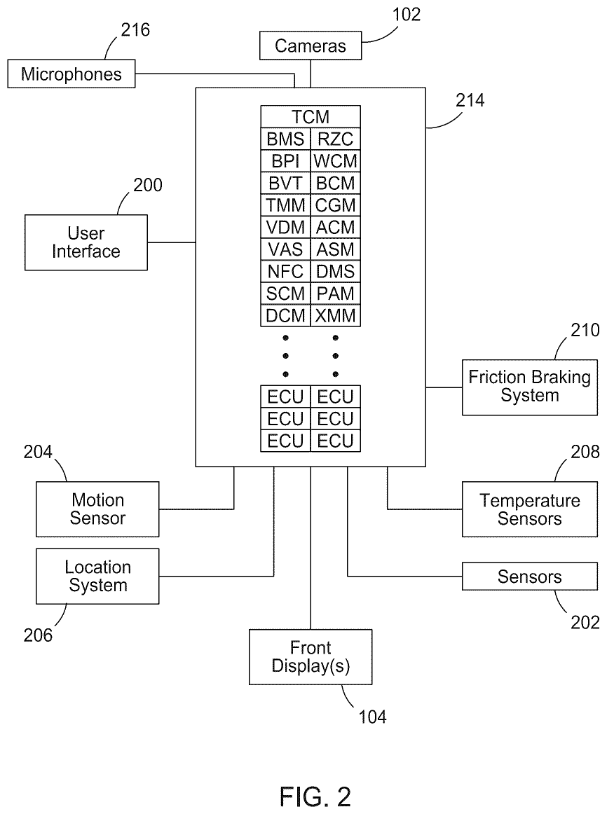

FIG. 2 illustrates example components of the vehicle 100 of FIG. 1A. As seen in FIG. 2, the vehicle 100 includes the cameras 102, the one or more front displays 104, a user interface 200, one or more sensors 202, a motion sensor 204, and a location system 206. The one or more sensors 202 may include ultrasonic sensors, radio detection and ranging (RADAR) sensors, light detection and ranging (LIDAR) sensors, or other types of sensors. The location system 206 may be implemented as a global positioning system (GPS) receiver. The user interface 200 allows a user, such as a driver or passenger in the vehicle 100, to provide input.

The components of the vehicle 100 may include one or more temperature sensors 208. The temperature sensors 208 may include sensors configured to sense an ambient air temperature, temperature of the battery 110, temperature of power electronics 114, temperature of each drive unit 112 and/or each motor of each drive unit 112, temperature of coolant fluid entering or leaving a coolant system, temperature of oil within a drive unit 112, or the temperature of any other component of the vehicle 100.

The components of the vehicle 100 may include a friction braking system 210. The friction braking system 210 may include any components of a hydraulic braking system, such as a rotor, brake pads, calipers, caliper pistons, a master cylinder coupled to the brake pedal and coupled to the caliper pistons by brake lines. The friction braking system 210 may further include a pump and/or valves for automatically applying hydraulic pressure to the caliper pistons. The friction braking system 210 may be implemented as a drum braking system or any friction braking system known in the art.

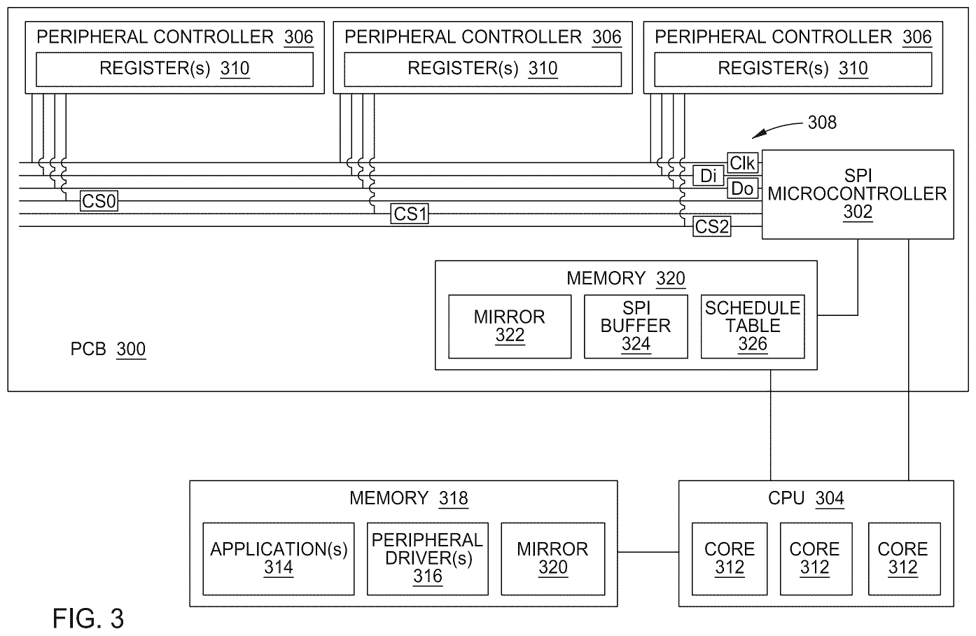

A control system 214 executes instructions to perform at least some of the actions or functions of the vehicle 100, including the functions described in relation to FIGS. 3 to 6. For example, as shown in FIG. 2, the control system 214 may include one or more electronic control units (ECUs) configured to perform at least some of the actions or functions of the vehicle 100, including the functions described in relation to FIGS. 3 to 6. In certain embodiments, each of the ECUs is dedicated to a specific set of functions. Each ECU may be a computer system and each ECU may include functionality described below.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102, sensors 202, motion sensor 204, location system 206, and temperature sensors 208. The sensor signals collected by the CGM ECU are then communicated to the appropriate ECUs for performing, for example, the operations and functions described below.

The control system 214 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU.

If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a Thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 216, etc.) to the TCM ECU.

The ECUs may include one or more ECUs that are configured to control the friction braking system 210. For example, the ECUs may include a traction control module, a stability control system, automated emergency braking (AEB) module, anti-lock braking system (ABS), adaptive cruise control module (ACC), and/or an automated driving assistance system (ADAS). The traction control module controls braking and acceleration to control wheel slip according to any approach known in the art. The traction control module may also control the torque applied at each wheel, i.e., torque vectoring. The stability control system controls braking and acceleration in order to avoid rollovers of the vehicle 100 according to any approach known in the art. The AEB module stops the vehicle 100 in a controlled manner response to predicted collisions according to any approach known in the art. The ABS modulates braking to maintain traction. The ACC maintains a speed of the vehicle while also maintaining a prescribed following distance with respect to other vehicles. The ADAS controls steering, acceleration, and braking of the vehicle 100 to arrive at a destination according to any self-driving approach known in the art.

Referring to FIG. 3, the control system 214 or any of the above-referenced components thereof may be implemented using the illustrated architecture. The illustrated architecture may be implemented on a common printed circuit board (PCB) 300. The control system 214 may include any number of PCBs 300.

The PCB 300 includes a SPI microcontroller 302 mounted thereto. The SPI microcontroller 302 is configured to mediate the exchange of data between a CPU 304 and a plurality of peripheral controllers 306 by way of a bus 308, such as an SPI bus. The peripheral controllers 306 may be specialized devices capable of only synchronous serial communication over the bus 308. The peripheral controllers 306 may include internal memory, such as in the form of one or more registers 310 or other type of memory (e.g., random access memory (RAM)). The SPI microcontroller 302 may manage the synchronous writing of data to and reading of data from the registers 310 of each peripheral controller 306. Although reference is made to a bus 308 and SPI microcontroller 302, other types of busses and corresponding microcontrollers may also be used in a like manner.

The bus 308 may be implemented by traces formed on the PCB 300. The bus 308 may be a serial bus including a single input line Di for inputting data to the peripheral controllers 306 and a single output line Do for receiving data from the peripheral controllers 306. As shown in FIG. 3, each peripheral controller 306 is connected to the same input and output lines Di, Do. The SPI microcontroller 302 and peripheral controllers 306 may be further connected to a common clock line CLK used to synchronize communication between the SPI microcontroller 302 CS0 and peripheral controllers 306.

The SPI microcontroller 302 is connected to each peripheral controllers 306 by a chip select line CS0, CS1, CS2 that is dedicated to that peripheral controller 306. A peripheral controller 306 is enabled to exchange data over the input and output lines Di, Do only when the chip select line CS0, CS1, CS2 connected thereto is asserted.

Each peripheral controller 306 is connected to a peripheral that is controlled by the peripheral controller 306 according to the values stored in the registers 310 thereof. The peripheral may be a light, motor, valve, solenoid, display device, another electronic device including one or more silicon chips, microprocessors, or other type of processing logic, or any other electronically controllable component of the vehicle 100.

The CPU 304 may include a plurality of cores 312 that may execute one or more applications 314. The applications 314 may be executed concurrently on multiple cores 312 and perform parallel access of the peripheral controllers 306 through the SPI microcontrollers 302 using the approach described below. One or more of the cores 312 may execute an operating system managing execution of the applications 314 and peripheral drivers 316.

The CPU 304 may further execute one or more peripheral drivers 316. The peripheral drivers 316 include executable code defining function calls (e.g., application programming interface (API)) that may be called by the applications 314 to invoke functions of the peripheral. Each peripheral driver 316 may respond to the function calls by generating one or more frames of data to be sent to the corresponding peripheral controller 306 by way of the SPI microcontroller 302 and bus 308. A memory 318 coupled to the CPU 304 may store executable code of the applications 314 and peripheral drivers 316.

A memory 320 may be mounted to the PCB 300. The memory 318 and memory 320 may be implemented as a single memory in some embodiments. The peripheral drivers 316 may make use of one or more data structures in the memory 320 to exchange information with the SPI microcontroller 302.

The memory 318 may store a mirror 322. The mirror 322 may store frames of data in a state that mirrors the storage of data within the registers 310 of each peripheral controller 306. The memory 320 may store an SPI buffer 324. The SPI buffer 324 may accumulate a block of data comprising a plurality of frames until the block of data is transferred to a schedule table 326. The schedule table 326 stores frames corresponding to a schedule executed by the SPI microcontroller 302 in which data referenced at specific indexes within the schedule table 326 are transmitted to a peripheral controller 306 within a specific time window of a sequence defined by a static schedule that the SPI microcontroller 302 is configured to follow.

The CPU 304 may communicate with the memory 318, memory 320, and SPI microcontroller 302 by way of a single data connection or multiple data connections each coupled to one of these components. Each data connection may be implemented as a peripheral component interconnect express (PCIe) bus or other type of bus, controller area network (CAN), ethernet network, or other type of data connection, including both wired and fiber optic types of connections.

The SPI microcontroller 302 may be connected to multiple buses 308 each with a corresponding set of peripheral controllers 306. The memory 320 may store a schedule table 326 for each bus 308 and possibly a mirror 322 and SPI buffer 324 for each bus 308. Alternatively, multiple busses may use the same mirror 322 and SPI buffer 324. The SPI microcontroller 302 may operate with respect to each bus 308 and corresponding peripheral controllers 306 as described below.

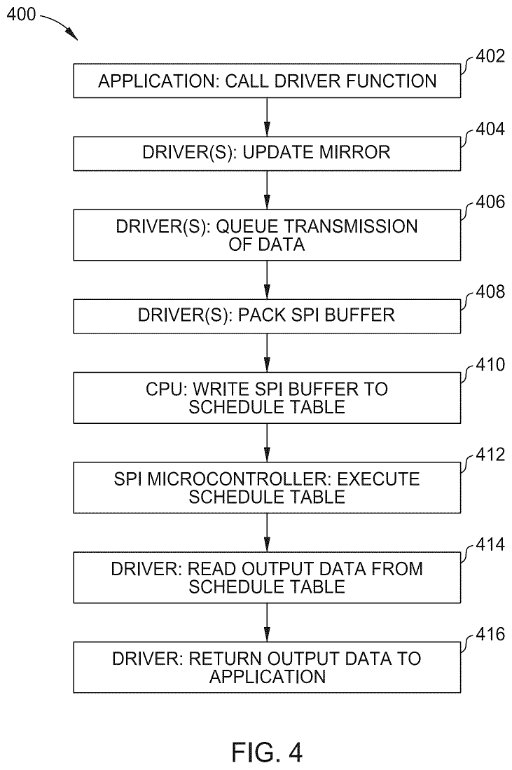

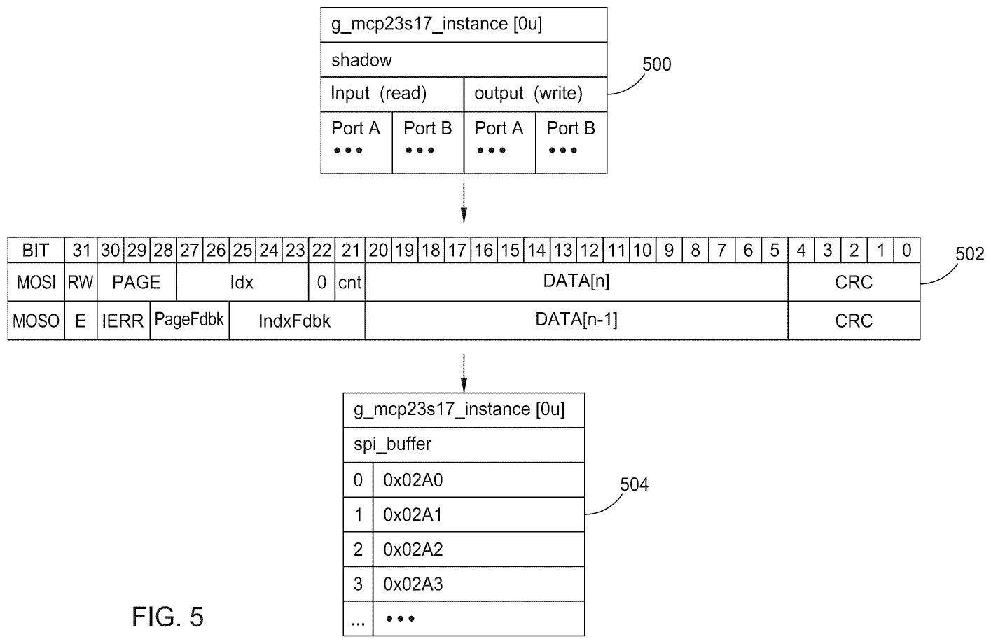

FIG. 4 illustrates a method 400 that may be executed using the architecture of FIG. 3. The method 400 is further described with reference to data structures shown in FIG. 5. The method 400 may include an application 314 calling, at step 402, a function of a peripheral driver 316. The function may instruct performance of an action, such as writing of data to a peripheral device, the reading of data from a peripheral device, transmission of an instruction to perform an action by the peripheral device, or other action. The peripheral driver 316 receives the function call and, at step 404, updates a portion of the mirror 322 corresponding to the peripheral driver 316. Step 404 may include the peripheral driver 316 executing instructions with which it is programmed in order to translate the function call at step 402, including any arguments, into one or more values that are formatted and composed such that, when written into the registers 310 of the peripheral controller 306 corresponding to the peripheral driver 316, the values will be processed by the peripheral controller 306 and perform the action corresponding to the function from step 402.

Table 500 of FIG. 5 illustrates data that may be written to the mirror 322. The table 500 shows a collection of items of data that each correspond to a register 310 of a particular peripheral controller 306 referenced by the function call from step 402. The table 500 may reference data to be read (e.g., from the listed port numbers), data to be written (e.g., the data to be written and references to registers to which the data is to be written, such as the listed port numbers), and possibly an identifier of the peripheral controller 306.

Steps 402 and 404 may be performed by one or more applications 314 with respect to one or more peripheral drivers 316. The one or more peripheral drivers 316 may invoke, at step 406, queuing the transmission of data from the mirror 322 to the SPI buffer 324. Queuing the transmission of data from the mirror 322 may include formatting data from the mirror 322 into frames that are added to a queue, or references to which are added to the queue.

FIG. 5 illustrates an example frame 502. Each frame may store one or more items of data corresponding to the registers of a single peripheral controller 306. Each frame 502 may store some or all of the data from table 500 along with other information, such as error correction codes, cyclic redundancy check (CRC) bits, or other information. The queue may then be processed by one or more peripheral drivers 316, at step 408, to instruct the packing of data from the frames in the mirror 322 into the SPI buffer 324. Step 408 may be performed by the SPI microcontroller 302 in response to a function call by the one or more peripheral drivers 316. The frames may be written to the SPI buffer 324 in the form of a data object, e.g., a “struct,” with attributes storing one or more items of data from the frames. The result of step 408 may be a buffer 504 (e.g., as shown in FIG. 5) in which each entry is one of the data objects.

The one or more peripheral drivers 316 may then invoke, at step 410, writing of the SPI buffer 324 to the schedule table 326. Writing of the SPI buffer 324 to the schedule table 326 may include writing a pointer to the schedule table 326 that references the data objects stored in the SPI buffer 324. Using a pointer may facilitate the performance of memory protection to prevent malicious or inadvertent reading or writing of data. Memory protection may be implemented by the CPU 304, such as the operating system executing on the CPU 304, using any approach known in the art. In particular, the portions of memory storing the data objects may be managed by memory protection as distinct areas to prevent errors or intrusion.

The schedule table 326 may have one or more items associated therewith to facilitate execution thereof. The one or more items may include, for example, rolling counters for tracking executions and failures, performance metrics (time left in a cycle, time of last transaction with a peripheral controller 306), indexes of the schedule table 326 where multiple schedule tables 326 are used with multiple buses 308, indexes of the current cycle and window being executed (see definition of cycle and window below), and a state of execution (running, stopped, reset) of the schedule table 326.

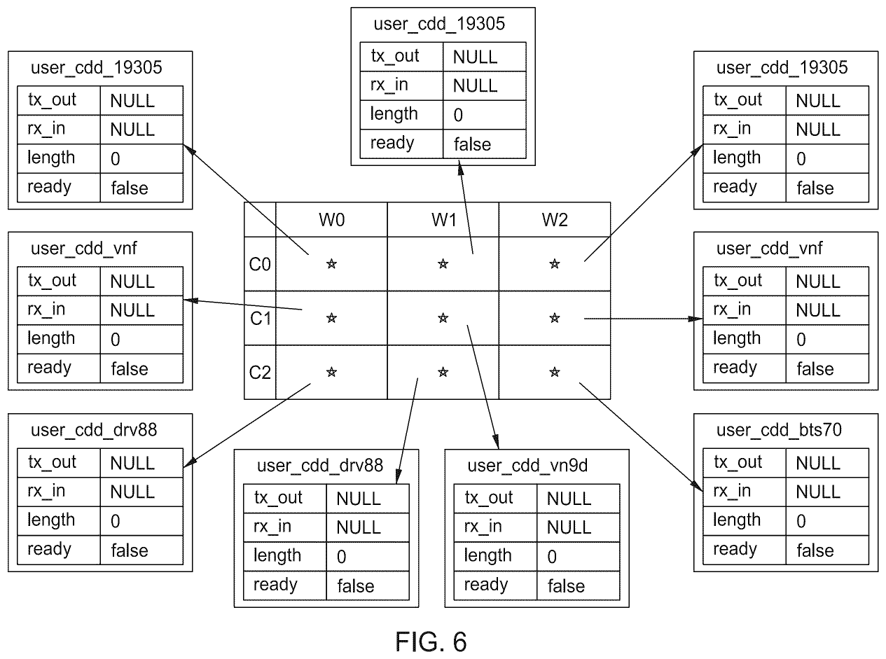

FIG. 6 illustrates an example configuration of the schedule table 326. The schedule table 326 may include a plurality of cycle entries C0, C1, C2, each cycle entry C0, C1, C2 including a set of window entries W0, W1, W2. Each window entry W0, W1, W2 corresponds to a different chip select line CS0, CS1, CS2 and to a different time window during execution of the schedule table 326. The entry for each window W0, W1, W2 of each cycle C0, C1, C2 stores a data structure or a pointer to a data structure. The data structure may include data to be transferred over the Di line of the bus 308 (“tx_out”) and data to be read from the Do line of the bus 308 (“rx_in”). The data structure may include a flag indicating that the entry is ready to be transmitted over the bus 308. For example, the flag may be set to false on startup and while data is being written to the data structure within the SPI buffer 324 and then set to true when writing of data to the data structure is complete. The flag may be set to false after the data structure has been processed by the SPI microcontroller 302 or remain true until reset in response to an instruction from a corresponding peripheral driver 316. The data structure may include a length indicating an amount of data stored in tx_out or to be stored in the rx_in.

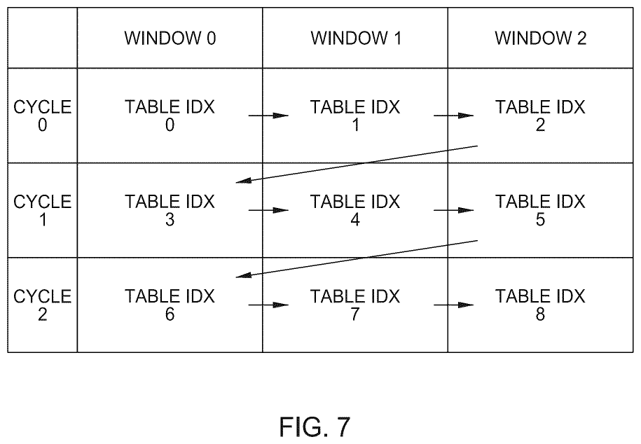

Referring to FIG. 7, while still referring to FIG. 4, the method 400 may include the SPI microcontroller 302 executing the schedule table 326 at step 412. As shown in FIG. 7, executing the schedule table 326 may be a static sequence of hardware commands transmitted over the bus 308 for each entry of the schedule table 326. Specifically, the SPI microcontroller 302 may process each entry in the schedule table 326 in sequence by processing each cycle C0, C1, C2 in order, including processing each window entry W0, W1, W2 of each cycle C0, C1, C2 in order. The processing of each entry corresponding to the same window W0, W1, W2 of the schedule table 326 may take an equal amount of time (e.g., an equal number of clock cycles on the clock line CLK). The processing of all entries corresponding to all windows W0, W1, W2 of the schedule table 326 may take an equal amount of time (e.g., 2.5 milliseconds) or may take an unequal amount of time in some embodiments.

The processing of each entry corresponding to a window W0, W1, W2 that is flagged as ready may include asserting the chip select line CS0, CS1, CS2 corresponding to that window W0, W1, W2 and, while doing so, executing one or more hardware commands relative to the peripheral controller 306 corresponding to the window W0, W1, W2 of the entry. The hardware commands may invoke writing data to the registers 310 and/or reading data from the registers 310 over the Di and Do lines, respectively. Executing hardware commands and transmitting and receiving data may be performed over the bus 308 according to a protocol that the SPI microcontroller 302 and the peripheral controller 306 is configured to perform. The hardware commands may be the same for each window W0, W1, W2 or may be different. For example, the SPI microcontroller 302 may be programmed with a set of commands adapted for each peripheral controller 306 that are executed for each window W0, W1, W2 corresponding to that peripheral controller 306.

In the case where an entry is flagged as not ready, processing of that entry may include not asserting the chip select line CS0, CS1, CS2 for the window W0, W1, W2 corresponding to the entry and either (a) waiting for a time period that is the same as when processing ready entries for that window W0, W1, W2 or (b) immediately executing the next entry without delay. Stated differently, the schedule table 326 may be processed according to a static schedule in that each entry is processed in turn according to a static schedule, and may further be static in that duration of processing for each entry in the schedule table 326 is the same regardless of whether that entry is flagged as ready.

Once all entries of the schedule table 326 are processed, processing repeats with the first cycle entry C0. In the example of FIG. 7, the order of processing the entries of the schedule table 326 is W0 of C0, C1, W1 of C0, W2 of C0, W0 of C1, W1 of C1, W2 of C1, W0 of C2, W1 of C2, and W2 of C2. There may be any number of windows and any number of cycles, the number of windows W0, W1, W2 corresponding to the number of chip select lines CS0, CS1, CS2 and the number of cycles C0, C1, C2 corresponding to available memory.

Referring again to FIG. 4, data output from a peripheral controller 306 during processing of an entry in the schedule table 326 may be written back to the entry, e.g., to the data structure pointed to by the entry. The peripheral driver 316 may then read, at step 414, the output data from the schedule table 326 by making a function call invoking this action. Reading at step 414 may be performed by issuing a command to the SPI microcontroller 302 or performing direct memory access (DMA) with respect to the memory 320. The peripheral driver 316 may then return, at step 416, the output data to the application 314 either as return data in response to the function call from step 402 or in response to a subsequent function call from the application 314.

The approach described above has many advantages. First of all, there is no opportunity for collisions on the bus 308. Secondly, the peripheral controllers 306 may have limited processing power and no ability to handle asynchronous communication. The use of static execution of the schedule table 326 accommodates this limitation. Thirdly, the populating of the mirror 322, SPI buffer 324, and the schedule table 326 may be performed simultaneous with execution of the schedule table 326. Direct memory access and multi-threaded operation may enable peripheral drivers 316 and applications 314 to execute simultaneously with one another and execution of the schedule table 326 without blocking. As long as an entry in the schedule table 326 is flagged as not ready, no action will be performed relative to the corresponding peripheral controller 306, enabling creation of an entry in the schedule table 326 to be performed asynchronously with respect to execution of the schedule table 326. Peripheral drivers 316 and applications 314 and the execution of the CPU 304 in general therefore need not be paused to wait for synchronous communication with a peripheral controller 306.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

While the foregoing is directed to embodiments of the present disclosure, other and further embodiments may be devised without departing from the basic scope thereof, and the scope thereof is determined by the claims that follow.

What is claimed is:

1. An apparatus comprising:
a printed circuit board;
a plurality of peripheral controllers mounted to the printed circuit board, each peripheral controller including one or more registers and configured to control operation of a corresponding peripheral according to values stored in the one or more registers;
a bus secured to the printed circuit board and including one or more data lines each data line of the one or more data lines coupled to each peripheral controllers of the plurality of peripheral controllers;
a memory mounted to the printed circuit board; and
a microcontroller mounted to the printed circuit board and coupled to the memory and the bus, the microcontroller configured to:
transmit and receive data to each peripheral controller of the plurality of peripheral controllers according to a static schedule in which, for each cycle of the static schedule, each time window of a plurality of time windows is statically dedicated to exchange of data with each peripheral controller of the plurality of peripheral controllers corresponding to each time window.

2. The apparatus of claim 1, wherein:
the bus further comprises a plurality of chip select lines, each chip select line coupled to a peripheral controller of the plurality of peripheral controllers coupled to each chip select line; and
the microcontroller is further configured to assert each chip select line coupled to each peripheral controller during a time window of the plurality of time windows statically dedicated to each peripheral controller.

3. The apparatus of claim 1, wherein the memory stores a schedule table, the microcontroller configured to, for each cycle of the static schedule and each window of the static schedule, process an entry in the schedule table corresponding to each cycle of the static schedule and each window of the static schedule.

4. The apparatus of claim 3, wherein each entry of the schedule table stores a pointer referencing a portion of the memory.

5. The apparatus of claim 4, wherein the schedule table stores a plurality of pointers referencing data objects in the memory.

6. The apparatus of claim 5, wherein the data objects each include data to be written to the one or more registers of a peripheral controller of the plurality of peripheral controllers.

7. The apparatus of claim 5, wherein the data objects each include a flag, the microcontroller configured to process each data object of the data objects only if the flag of each data object indicates that each data object is ready.

8. The apparatus of claim 5, further comprising a processing device coupled to the microcontroller, the processing device configured to:
write the data objects to the memory in response to instructions from one or more peripheral drivers executed by the processing device.

9. The apparatus of claim 8, wherein the processing device is further configured to:
write the data objects to the memory asynchronously with respect to the static schedule.

10. The apparatus of claim 1, further comprising the corresponding peripheral for each peripheral controller of the plurality of peripheral controllers, the corresponding peripheral for each peripheral controller of the plurality of peripheral controllers being an electronically controllable component of a vehicle.

11. The apparatus of claim 10, wherein the corresponding peripheral for each peripheral controller of the plurality of peripheral controllers includes at least one of a light, a motor, or a valve.

12. A vehicle comprising:
a chassis;
a plurality of suspensions mounted to the chassis;
a plurality of wheels mounted to the chassis;
a plurality of electronically controllable components mounted to the chassis;
a printed circuit board mounted to the chassis;
a plurality of peripheral controllers mounted to the printed circuit board, each peripheral controller including one or more registers and configured to control operation of a corresponding electronically controllable component of the plurality of electronically controllable components according to values stored in the one or more registers;
a bus secured to the printed circuit board and including one or more data lines, each data line of the one or more data lines coupled to each peripheral controllers of the plurality of peripheral controllers;
a memory mounted to the printed circuit board; and
a microcontroller mounted to the printed circuit board and coupled to the memory and the bus, the microcontroller configured to:
transmit and receive data to each peripheral controller of the plurality of peripheral controllers according to a static schedule in which for each cycle of the static schedule, each window of a plurality of windows is statically dedicated to exchange of data with a peripheral controller of the plurality of peripheral controllers corresponding to each window.

13. The vehicle of claim 12, wherein:
the bus further comprises a plurality of chip select lines, each chip select line coupled to a peripheral controller of the plurality of peripheral controllers; and
the microcontroller is further configured to assert each chip select line coupled to each peripheral controller during a window of the plurality of windows statically dedicated to each peripheral controller.

14. The vehicle of claim 12, wherein the memory stores a schedule table, the microcontroller configured to for each cycle of the static schedule and each window of the static schedule, process an entry in the schedule table corresponding to each cycle of the static schedule and each window of the static schedule.

15. The vehicle of claim 14, wherein each entry of the schedule table stores a pointer referencing a portion of the memory.

16. The vehicle of claim 14, wherein the schedule table stores a plurality of pointers referencing data objects in the memory.

17. The vehicle of claim 16, wherein the data objects each include data to be written to the one or more registers of a peripheral controller of the plurality of peripheral controllers.

18. The vehicle of claim 16, wherein the data objects each include a flag, the microcontroller configured to process each data object of the data objects only if the flag of each data object indicates that each data object is ready.

19. The vehicle of claim 16, further comprising a processing device coupled to the microcontroller, the processing device configured to:
write the data objects to the memory in response to instructions from one or more peripheral drivers executed by the processing device;
wherein the processing device configured to write the data objects to the memory asynchronously with respect to the static schedule.

20. The vehicle of claim 12, wherein the plurality of electronically controllable components include at least one of a light, a motor, or a valve.
